(19) United States
(12) Patent Application Publication
(10) Pub. No.: US 2018/0166954 A1
(43) Pub. Date: Jun. 14, 2018

(54) ELECTRICAL MACHINE WITH BRUSH AND COMMUTATOR HAVING A SPECIFIC DISTRIBUTION OF ELECTRICAL CONDUCTIVITY FOR SUPPRESSION OF SPARKING

(71) Applicants: SCHUNK HOFFMANN CARBON TECHNOLOGY AG, Bad Goisem (AT); AC2T RESEARCH GMBH, Wiener Neustadt (AT)

(72) Inventor: Laszlo Katona, Babarc (HU)

(73) Assignees: SCHUNK HOFFMANN CARBON TECHNOLOGY AG, Bad Goisern (AT); AC2T RESEARCH GMBH, Wiener Neustadt (AT)

(21) Appl. No.: 15/111,079

(22) PCT Filed: Jun. 2, 2015
(86) PCT No.: PCT/EP2015/062271

§ 371 Date: Jul. 12, 2016

(51) Int. Cl. H02K 13/10; H01R 39/26; H01R 39/04; H01R 39/20

(52) U.S. Cl. CPC H02K 13/105; H01R 39/20; H01R 39/045; H01R 39/26

(57) ABSTRACT

An electrical machine with a brush commutator arrangement (1) is proposed. Brushes (3) and a commutator (5) are adapted and arranged such that, upon operating the electrical machine (1), the brush (3) and the commutator (5) are displaced relative to each other in a lateral displacement direction (7) and a contact surface (9) of the brush (3) mechanically contacts a contact surface (11) of the commutator (5) along an overlapping area (13) thereby generating an electrical contact. Accordingly, an electric current is transmitted between brush (3) and commutator (5) through the overlapping area (13). An orthogonal electrical conductivity of the brush (3) and/or the commutator (5) in a direction (25) orthogonal to a respective contact surface (9, 11) locally varies along the lateral displacement direction (7). An orthogonal electrical conductivity distribution in the brush (3) and/or the commutator (5) is adapted such that, even when operating the electrical machine at maximum allowable power, for at least 90% of all spatial configurations during displacing the brush (3) and the commutator (5) relative to each other, an electrical current density through the overlapping area (13) does not exceed 130% of a rated maximal average electrical current density through the brush commutator arrangement (1). Due to the specific variation of orthogonal electrical conductivity within the brush (3) or commutator (5), sparking and resulting wear in the proposed brush commutator arrangement (1) may be reduced.

### FIELD OF THE INVENTION

The present invention relates to an electrical machine comprising a brush commutator arrangement.

### BACKGROUND OF THE INVENTION

Electrical machines may serve as motors or generators and may be applied in various applications. Multiple types of electrical machines exist. In one type, a rotor may rotate relative to a stator and the rotor is driven by interaction of magnetic fields generated by electromagnets comprised in the rotor with magnetic fields generated by permanent magnets or electromagnets comprised in the stator. In such approach, electric power has to be supplied to the rotor and its electromagnets.

Usually, a brush commutator arrangement is used for such electric power supply. Typically, two or more brushes are provided at a fixed position such as at the stator and a commutator with two or more lamellae is provided at the rotor. The commutator may move relative to the brushes. The brushes are electrically connected to an electric power source such as a DC power source. The commutator is electrically connected to the electromagnets of the stator. The brushes come into electrical contact with the commutator via a contact area at which the brushes mechanically contact a surface of the commutator. During operation of the electrical machine, the brushes slide over the surface of the rotating commutator and thereby provide electric power to the rotor's electromagnets.

An example of an electrical machine and a brush commutator arrangement comprised therein is described in WO 2009/083433 A1.

It has been observed that upon operating electrical machines comprising brush commutator arrangements significant wear may occur at the brushes and/or at the commutator.

### SUMMARY OF THE INVENTION

There may be a need for an improved electrical machine comprising a brush commutator arrangement having e.g. reduced wear upon operation.

Such need may be met by an electrical machine as defined in the independent claim. Advantageous embodiments are defined in the dependent claims.

According to an aspect of the present invention, an electrical machine with a specific brush commutator arrangement comprising at least two brushes and a commutator is proposed. Therein, each of the brushes and the commutator are adapted and arranged such that, upon operating the electrical machine, the brush and the commutator are displaced relative to each other in a lateral displacement direction and a contact surface of the brush comes into mechanical contact with a contact surface of the commutator along an overlapping area thereby generating an electrical contact between the brush and the commutator along the overlapping area. Upon such electrical contact, an electric current is transmitted between the brush and the commutator through the overlapping area. Furthermore, an electrical conductivity of the brush and/or of the commutator in a direction orthogonal to the contact surface of the brush and/or of the commutator, respectively, locally varies along the lateral displacement direction. Such electrical conductivity in a direction orthogonal to the contact surface of the brush and/or of the commutator, and therefore also orthogonal to the displacement direction, will be referred to herein as “orthogonal electrical conductivity”. An orthogonal electrical conductivity distribution in the brush and/or in the commutator shall be specifically adapted such that, even when operating the electrical machine at maximum allowable power, for at least 90% of all spatial configurations during displacing the brush and the commutator relative to each other, an electrical current density through the overlapping area does not exceed 130% of a rated maximal average electrical current density through the brush commutator arrangement.

While details on ideas and observations underlying embodiments of the present invention will be described further below, some general ideas and observations may be summarized as follows:

It has been observed that sparking between a brush and a commutator may occur and may be responsible for wear and deterioration of the brush commutator arrangement. Such sparking particularly occurs when the overlapping area between the contact surface of the brush and the contact surface of the commutator reduces in size, i.e. when, during rotation of the commutator, the brush moves over a lateral edge of a commutator lamella.

While these effects have been observed but have been understood at most qualitatively, the inventors of the present invention have developed a model which allows some quantitative understanding of the effects and therefore allows for defining quantitative measures for reducing or even preventing such effects.

Particularly, it has been found that properties in a material used for forming the brushes or the commutator may be affected such that the orthogonal electrical conductivity, i.e. the electrical conductivity in a direction orthogonal to contact surfaces, in the material of the brush or of the commutator varies in a direction parallel to the contact surface. Accordingly, the orthogonal electrical conductivity may e.g. be higher in a region close to a leading edge of a brush or a commutator, i.e. where the contact surfaces of the brush and the commutator first come into contact upon rotating relative to each other, than in a region close to a trailing edge.

While such adapting of material properties in brushes or commutators with respect to their electrical conductivities has been performed already in prior electrical machines such as described e.g. in WO 2009/083433 A1, the effects of such adaptions have not been understood or modelled quantitatively. Accordingly, it was not possible to optimize the variations in the orthogonal electrical conductivity based on any quantitative models or simulations.

The inventors have developed a model in which characteristics of a brush commutator arrangement may be simulated and analysed quantitatively.

Analysing simulation results revealed that properties of a brush commutator arrangement may be improved when the orthogonal electrical conductivity distribution in the brush and/or in the commutator is adapted in such a manner that an electrical current density through the overlapping area between the brush and the commutator does not exceed 130%, or preferably not exceed 110%, of a rated maximal average electrical current density through the brush commutator arrangement.

The rated maximal average electrical current density, hereinafter also abbreviated as “RMAECD”, is the electrical current density which, for a given electrically conductive material for a brush or a commutator, shall not be exceeded and which is generally indicated by the producer or supplier of such brush/commutator material as an averaged value over a typical contact area between the brush and the commutator.

The limiting of the electric current density should apply even when operating the electrical machine at maximum allowable power, i.e. at a maximum power rated e.g. by the producer of the electrical machine.

While it might be advantageous to accordingly limit the electric current density for all possible configurations of the brush commutator arrangement, i.e. for all possible positioning of the commutator relative to the brushes during their relative rotation movement, it might be sufficient to accordingly limit the electric current density for at least 90% of all spatial configurations during displacing the brush and the commutator relative to each other.

Experiments showed that, by specifically adapting a varying orthogonal electric conductivity in a brush or commutator as a result of suitably choosing or effecting material properties of the brush or commutator, wear of the brush commutator arrangement can be significantly reduced. Particularly, it has been observed that if the orthogonal electric conductivity e.g. in a brush is varied in sections of the brush such that at no configuration or only very few configurations during displacing the brush relative to the commutator an electrical current density exceeds the rated maximal average electrical current density through the brush arrangement, sparking may be significantly suppressed thereby reducing any deteriorating wear.

According to an embodiment, with respect to the lateral displacement direction, an orthogonal electrical conductivity in a first section of the brush is higher than an orthogonal electrical conductivity in a second section of the brush arranged downstream of the first section of the brush. Alternatively or additionally, an orthogonal electrical conductivity in a first section of the commutator is higher than an orthogonal electrical conductivity in a second section of the commutator arranged upstream of the first section of the commutator.

In other words, generally, the orthogonal electrical conductivity in a brush and/or in a lamella of the commutator should be higher close to its leading edge compared to close to its trailing edge. Accordingly, when a brush comes close to and moves over the trailing edge of a commutator lamella and the overlapping area between the contact surface of the brush and the contact surface of the commutator progressively reduces, the electrical current through such diminishing overlapping area reduces due to the progressively reducing orthogonal electrical conductivity. As a result, the electrical current density does not or only very briefly exceed the limit of 130% or 110% of the RMAECD and no or only few sparking occurs.

Therein, according to an embodiment, an average orthogonal electrical conductivity throughout an area unit within the first section of the brush is at least five times, preferably ten times, higher than an average orthogonal electrical conductivity throughout an area unit within in the second section of the brush. Alternatively or additionally, an average orthogonal electrical conductivity throughout an area unit within the first section of the commutator is at least five times, preferably ten times, higher than an average orthogonal electrical conductivity throughout an area unit within the second section of the commutator.

In other words, the average orthogonal electrical conductivity in a unit area close to the leading edge of the brushes and/or of lamellae of the commutator should preferably be more than five or even more than ten times higher than in a unit area close to the trailing edge. Such significant variations in orthogonal electrical conductivity along the lateral displacement direction of contact surfaces of brushes and/or lamellae of the commutator have been found to effectively suppress sparking or arcing.

According to another embodiment, the brush and/or the commutator comprise at least a first section, a second section and a third section arranged behind each other along the lateral displacement direction and having different orthogonal electrical conductivities.

In other words, the brushes and or the lamellae of the commutator may comprise at least three layers or portions forming different sections, a first section being close to the leading edge, a second section being central and a third section being close to the trailing edge. These sections differ in their orthogonal electrical conductivities as a result of e.g. differing materials or material compositions.

Therein, according to an embodiment, an average orthogonal electrical conductivity throughout an area unit within the first section of the brush and/or of the commutator, respectively, is at least five times, preferably at least ten times, higher than an average orthogonal electrical conductivity throughout an area unit within in the second section of the brush and/or of the commutator, respectively. Furthermore, an average orthogonal electrical conductivity throughout the area unit within the second section of the brush and/or of the commutator, respectively, is at least five times, preferably at least ten times, higher than an average orthogonal electrical conductivity throughout an area unit within in the third section of the brush and/or of the commutator, respectively.

In other words, the brushes and/or lamellae of the commutator may have an orthogonal electrical conductivity which is at least 25 times higher in a region close to the leading edge than in a region close to the trailing edge. Such significant variations in orthogonal electrical conductivity along the lateral displacement direction of contact surfaces of brushes and/or lamellae of the commutator have been found to effectively suppress sparking or arcing.

According to an embodiment, in the brush and/or in the commutator, the orthogonal electrical conductivity continuously varies in the lateral displacement direction.

In other words, the orthogonal electrical conductivity gradually changes along the lateral displacement direction preferably from a high value close to the leading edge to a low value close to the trailing edge of the brushes/lamellae. Such gradually changing orthogonal electrical conductivity may help preventing occurrence of any excessive peak values in electrical current density throughout the displacement of the brushes relative to the commutator lamellae. However, preparing a material having continuously varying orthogonal electrical conductivities along a lateral displacement direction may be technologically challenging.

According to an alternative embodiment, in the brush and/or in the commutator, the orthogonal electrical conductivity varies in a step-wise manner in the lateral displacement direction.

In other words, the brushes and/or lamellae of the commutator may have various sections arranged behind each other along the lateral displacement direction and each section may have a single homogeneous orthogonal electrical conductivity. Such homogenous single sections may be easily produced and stacked.

According to an embodiment, in the brush and/or in the commutator, the electrical conductivity is anisotropic and an orthogonal electrical conductivity in the direction orthogonal to the respective contact surface is substantially higher than a lateral electrical conductivity in the direction parallel to the respective contact surface.

In other words, the material of the brush and/or of the commutator is not isotropic with respect to its electrical conductivity. Instead, it shows significantly higher electrical conductivity in a direction orthogonal to the respective contact surface than in a lateral direction. Such anisotropy may result from anisotropic characteristics of a brush/commutator material. For example, the material may have a granular structure with grains being mainly oriented in a specific direction. Due to such anisotropy, an electrical current may easily flow in an orthogonal direction, i.e. for example from an electrical supply line contacting the brush or lamella at a rear side to the respective opposite front side contact surface. However, any lateral electrical currents parallel to the displacement direction may hardly flow due to the low electrical conductivity in this direction.

According to a specific form of this embodiment, the orthogonal electrical conductivity is at least 50% higher than the lateral electrical conductivity. For example, the orthogonal electrical conductivity and the lateral electrical conductivity may differ by a factor of at least two, preferably by a factor of at least five, ten or even more. Such factors may be achieved e.g. by using specific types of graphites and/or by incorporating hexagonal boron nitrides into a graphite body.

According to an embodiment, the brush and/or the commutator are made from a material in which carbon provides for a major contribution to the electrical conductivity.

In other words, the brushes and/or lamellae of the commutator may be made e.g. from a substantial volume part of graphite material. This graphite material may provide for a major contribution of the entire electrical conductivity of the brush/commutator. Generally, this is in contrast to many conventional brushes/commutators in which e.g. a copper content is higher than a graphite content and provides for a major portion or the device's electrical conductivity.

According to the present embodiment, optionally, additives such as binders or electrically conductive particles such as metal particles may be included in the base material but do not provide for a major conductivity of the brush/commutator. Such mainly carbon based materials may provide for beneficial characteristics of brushes and/or lamellae. For example, the graphite material may reduce a friction coefficient and it has little wear. Its shape and the intrinsic anisotropy of the graphite crystal are generally the origins of the anisotropy of the part's electrical conductivity which is often helpful for commutation. Additional Copper may be helpful in some applications to give high electrical performance due to its high electrical conductivity.

According to an embodiment, the orthogonal electrical conductivity of the brush and/or the commutator locally varies along the lateral displacement direction as a result of a varying content of at least one of graphite flakes, binder components and boron-nitride comprised in a carbon matrix.

In other words, in a carbon based material, the orthogonal electrical conductivity may be varied by purposively varying a content or size distribution of graphite flakes comprised in the material. Alternatively or additionally, binder components and their concentrations in the carbon matrix may be varied. Further alternatively or additionally, boron-nitride particles or particles of other lamellar materials such as MoS₂ or WS₂ particles may be comprised in the carbon matrix in varying concentrations and affect its electrical conductivity.

According to an embodiment, the electrical machine is adapted for being applied in a fuel pump. It has been found that particularly in electrical machines for fuel pumps of vehicles, wear may be significantly reduced when providing their brushes and/or commutator with varying orthogonal electrical conductivities as described herein. In vehicle fuel pumps, an electrical machine has to operate under specific conditions such as liquid fuel contacting the brushes and/or commutator. In prior fuel pumps, such conditions appear to support an occurrence of sparking which may be suppressed with the specific embodiments of the present invention. However, embodiments of the invention may also be applied in other electrical machines such as motors for an electrical starter of a vehicle or motors for an ABS (Anti Blocking System) arrangement in a vehicle or other applications.

It should be pointed out that possible features and advantages of embodiments of the invention are described herein in relation to various details of the electrical machine or the brush commutator arrangement. A person skilled in the art will recognise that the various features may be combined, modified or replaced in order to create further embodiments and to possibly obtain synergy effects.

### BRIEF DESCRIPTION OF THE DRAWINGS

Possible aspects, features and advantages of embodiments of the present invention are apparent from the following description of specific embodiments with reference to the enclosed drawings, wherein said description and drawings are not to be interpreted as restricting the invention.

FIG. 1 shows a front view of an electrical machine indicating principles of a brush commutator arrangement.

FIG. 2 shows a partial side view of a brush commutator arrangement of an electrical machine according to an embodiment of the present invention.

FIG. 3 illustrates sections and overlapping areas of a brush and a commutator in a brush commutator arrangement of an electrical machine according to an embodiment of the present invention along the line A-A of FIG. 2.

The drawings are merely schematic and are not true to scale. Same reference signs indicate same or similar features throughout the various drawings.

### DESCRIPTION OF PREFERRED EMBODIMENTS OF THE INVENTION

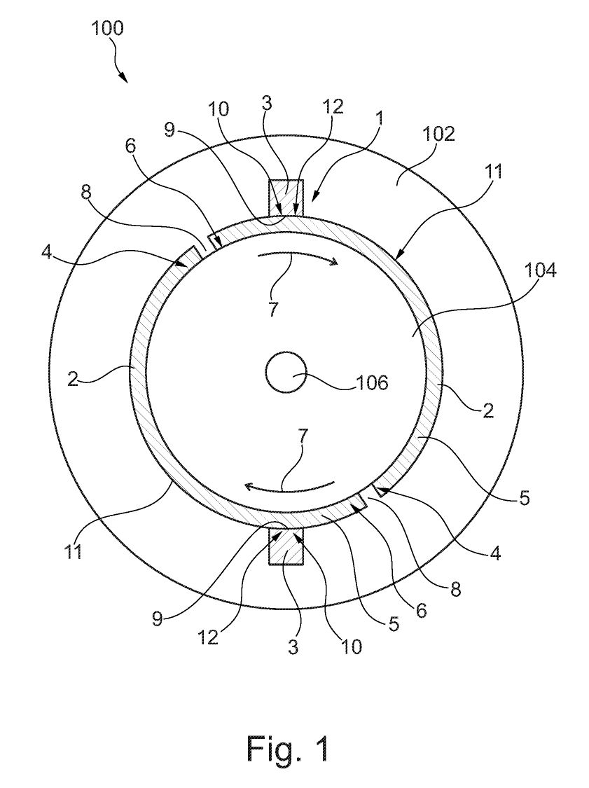

FIG. 1 illustrates basic features of an electrical machine 100. The electrical machine 100 comprises a stator 102 and a rotor 104. The stator 102 comprises several permanent magnets or electro-magnets (not shown) arranged along the circumference of the stator 102. The rotor 104 comprises electromagnets (not shown) arranged along the circumference of the rotor 104. The rotor 104 may be rotated around an axis 106 relative to the fixed stator 102.

In order to supply electric power to the electromagnets in the rotatable rotor 104, a brush commutator arrangement 1 is provided. The brush commutator arrangement 1 comprises at least two brushes 3 and a commutator 5 having at least two lamellae 2. The brushes 3 are arranged at fixed positions and may be fixed for example at the stator 102. The commutator 5 may rotate together with the rotor 104 and may be e.g. fixed thereto.

Accordingly, upon operating the electrical machine 100, electric power is transmitted from the brushes 3 to the commutator 5 and is then further transmitted to the electromagnets. As the electromagnets generate magnetic fields upon such power supply and these magnetic fields interact with magnetic fields generated by the permanent magnets of the stator 102, forces onto the rotor 104 are generated such that the rotor 104 will rotate relative to the stator 102. Upon such rotation, the commutator 5 is continuously displaced with respect to the brushes 3. In the simple design shown in FIG. 1, such displacement will continue for an almost 180° rotation. Then, the brushes 3 will arrive at a gap 8 in the commutator 5, such gap separating a first lamella 2 of the commutator 5 from a second lamella 2 of the commutator 5.

When each of the brushes 3 releases contact to one of the two lamellae 2 of the commutator 5 at their trailing edges 6 and then come into contact with the other one of the lamellae 2 of the commutator at their leading edges 4, a polarity of the electricity supplied to the electromagnets in the rotor 104 is reversed. Due to such reversal, the rotor 104 continues its rotating motion and the commutator 5 is continuously displaced in a lateral displacement direction 7 relative to the brushes 3 as indicated with the arrow in FIG. 1.

Upon rotation of the rotor 104 and corresponding motion of the commutator 5 in the lateral displacement direction 7, contact surfaces 9 of the brushes 3 slide along and come into contact with contact surfaces 11 of the lamellae 2 of the commutator 5 such that an electric current can be transmitted from the brushes 3 to the commutator 5. Upon such rotation, the contact surface 9 of the brushes first contacts a lamella 2 of the commutator 5 at its leading edge 4, then moves along the contact surface 11 and, finally, the contact is released at a trailing edge 6.

Therein, when the leading edge 4 arrives at the brush 3, the contact surface 11 of the commutator 5 first contacts the contact surface 9 of the brush 3 at a leading edge 10 of the brush 3 and, after rotating the commutator 5 for almost 180°, the contact is released at a trailing edge 12 of the contact surface 9 of the brush 3.

It has been observed that wear and erosion of the brush commutator arrangement 1 mainly occurs at the leading edges 4, 10 and particularly at the trailing edges 6, 12 of the lamellae 2 of the commutator 5 and the brushes 3, respectively.

Generally, it is assumed that any sparking or arching between two bodies forming an electrical contact only occurs when a specific ignition voltage is exceeded and a minimum contact current may flow.

For example, when two carbon contacts provide an electrical contact, such ignition voltage is in the order of 20 V and the minimum contact current is at least about 100 mA. Generally, the ignition voltage and the minimum contact current depend, inter alia, on the materials of the contacts and their geometry or topography.

Under normal operation conditions of an electrical machine, theoretically, an ignition voltage and a minimal contact current should not be exceeded at any point in time. However, such theory is based on the voltages and currents externally supplied to the brush commutator arrangement of the electrical machine and assumes that there is a large area contact between the contact surfaces 9 of the brushes 3 and the contact surfaces 11 of the commutator 5.

However, such macroscopic large area contact does probably not correctly represent a microscopic reality of a contact between the contact surfaces 9, 11 of the brushes 3 and the commutator 5. In reality, these contact surfaces 9, 11 are not ideally planar and do therefore not form a large area mechanical contact along an entire area of neighbouring portions of the contact surface 9 of the brush 3, on the one hand, and the contact surface 11 of the commutator 5, on the other hand. Instead, microscopic small contact spots with sizes in an order of square micrometres appear to form. Due to such contact spot formation, an electric current may not flow from a brush 3 to the commutator 5 through a large overlapping contact surface but has to focus only on the limited area of the contact spots. Accordingly, at these contact spots, a significantly increased local electric current density may occur.

It may be assumed that it is the conduction mechanism through contact spots and the resulting increase in local electric current density which finally results in sparking or arching between the brushes 3 and the commutator 5.

Particularly, when a brush 3 is at or close to a gap 8 between lamellae 2 of the commutator 5, only partial areas of the contact surface 9 of the brush 3 come into contact with partial areas of the contact surface 11 of the commutator 5. Accordingly, immediately before completely releasing an electrical contact between the brush 3 and the commutator 5 at trailing edges 6, 12 of the contact surfaces 9, 11, an electrical power transmitted through contact spots between these contact surfaces 9, 11 may excessively increase. Due to such increase in transmitted electric power, local failure of the contact spots may occur. For example, material of the brush 3 and/or the commutator 5 may abruptly heat and thereby melt or evaporate such that some or all of the contact spots may suddenly be interrupted when the brush 3 comes close to a trailing edge 6 of the commutator 5. However, as at that point in time a commutation process is not yet finished, i.e. a current of the coil has not yet reached its commutated value and/or the brush 3 has not yet completely reached the gap 8, an electric current through windings of the electromagnets in the rotor 104 significantly changes within a short time period. As a result thereof, a large electric voltage is induced. This induced voltage may then significantly increase the electrical potential difference between the brush 3 and the commutator 5 thereby exceeding the ignition voltage. Such excessive voltage together with an electrical current which, at the moment of abrupt interruption of the electric contact between brush 3 and commutator 5 still exceeds the minimal contact current necessary for an arc ignition at such voltage, may result in an arc being ignited between the brush 3 and the commutator 5.

The inventors have implemented the above possible theory for explaining arcing and sparking in a brush commutator arrangement into a computer model. Various simulations have been performed using this computer model and good correspondence between simulation results and experiments have been observed.

Based on an analysis of the simulation result, the inventors found that an electric current density through an overlapping area between a contact surface 9 of the brush 3 and a contact surface 11 of the commutator 5 should be limited to remain below a certain current density limit.

While such limiting of the electric current density may not be possible for all spatial configurations during displacing the commutator 5 with respect to the brush 3 along the displacement direction 7, the electrical current density should be limited to below the maximum current density limit for at least 90% or preferably at least 95% or 98% of all such spatial configurations.

It has been found that determining a maximum current density limit for a specific brush commutator arrangement may be a difficult task. Generally, such limit strongly depends on the materials forming an electrical contact and of structural characteristics at contact surfaces 9, 11 forming the electrical contact. Material characteristics may include, inter alia, specific electrical resistivities of the material, an anisotropy of such electrical resistivities, a spatial distribution of the electrical resistivities, temperature behaviours, etc. The structural characteristics may include, inter alia, surface properties such as smoothness or curvature of contact surfaces 9, 11 or a geometry of an overlapping area between such contact surfaces 9, 11. Due to such many influences, it may be difficult to precisely determine a maximum current density limit for a specific brush commutator arrangement. In fact, it may be necessary to perform specific simulations and/or experiments for determining such limit value for a specific type and configuration of contact.

However, the inventors have found that a suitable and reliable approximation for determining such limit value may be made based on a rated maximal average electric current density through the brush commutator arrangement 1. Such rated maximum average electrical current density “RMAECD” is a value which is generally indicated by a producer of a brush 3, a commutator 5 or an entire brush commutator arrangement 1. It has been found that when an electrical current density through an overlapping area between a contact surface 9 of the brush 3 and a contact surface 11 of the commutator 5 does not exceed 130%, preferably not exceed 110%, of the rated maximal average electrical current density through the brush commutator arrangement 1, wear or erosion of the brush commutator arrangement 1 may be significantly reduced.

It may be seen as a main idea underlying the present invention to limit the electric current density through the overlapping area to below such maximum limit value by specifically adapting an orthogonal electrical conductivity distribution in the brush and/or the commutator. Therein, the orthogonal electrical conductivity should be adapted such as to vary along the lateral displacement direction 7. Preferably, the orthogonal electrical conductivity is set to be much smaller in an area close to a trailing edge 6, 12 of the commutator 5 and/or the brush 3 than in an area further upstream of such trailing edge 6, 12, i.e. closer to the respective leading edge 4, 10.

Generally, as a kind of “rule of thumb”, in order to achieve a satisfying commutation of an electrical machine having a brush commutator arrangement 1, an electric conductivity in a contact area between a brush 3 and a lamella 2 of the commutator 5 should be adapted such that the following assumptions and/or requirements are fulfilled:
The orthogonal electrical conductivity in the brush 3 and/or commutator 5 should be large in areas being far from a trailing edge 12, 6 and should reduce towards the trailing edge 12, 6. Particularly, such orthogonal electrical conductivity should reduce over-proportional towards the trailing edge 12, 6 when compared to a number of contact spots in an overlapping area between a contact surface 9 of the brush 3 and a contact surface 11 of the lamellae 2 of the commutator 5.
Thereby, a current to the commutator 5 at a time just before opening the contact between the brush 3 and the commutator 5 and a corresponding electrical current density may be limited to below a specific acceptable limit value of for example 130% of the rated maximal average electric current density through the brush commutator arrangement 1.
Accordingly, a condition in which electrical contacts between the brush 3 and the commutator 5 may no more carry a transmitted electric power may suitably be prevented.
An electrical supply of a commutating coil of electromagnets in the rotor 104 may be taken over by the next lamella 2 of the commutator 5 sufficiently before finally opening a contact of the brush 3 to the preceding lamella 2 of the commutator 5, thereby enabling earlier complete commutation.

As it is taught herein that an orthogonal electrical conductivity distribution in the brush 3 and/or the commutator 5 should be adapted such that an electrical current density through the overlapping area of the contact surface 9 of the brush 3 and the contact surface 11 of the commutator 5 does not exceed 130% of a rated maximal average electrical current density (RMAECD) through the brush commutator arrangement 1, it shall be noted that RMAECD generally is no arbitrary value but is specifically determined for each brush commutator arrangement 1.

Typically, the RMAECD is indicated by a producer of a brush commutator arrangement in a written data sheet thereof. The RMAECD is generally determined based on experiments which evaluate certain wear or deterioration characteristics of the brush commutator arrangement upon transmission of varying values of electrical current density.

For example, experiments may use a commutator ring or slip ring being in contact with a brush and being operated under similar conditions as assumed for later actual operation of the brush commutator arrangement. First, a low value for the current density may be established and an associated wear of the brush and/or the commutator may be determined. Then, the electrical current density may be progressively increased and wear of the brush and/or commutator may be monitored. When a specific electric current density is exceeded, such wear begins to increase abruptly. The electrical current density at which the wear increases by 20% is typically set as RMAECD.

It may be mentioned that in such experiments for determining the RMAECD, it should be considered that for example power supply lines to the brush have a sufficient cross-section in order to ensure that experimental results mainly represent characteristics of the materials used in the brush commutator arrangement and are not excessively influenced for example by a specific design of a brush or by the dimensions of the power supply lines.

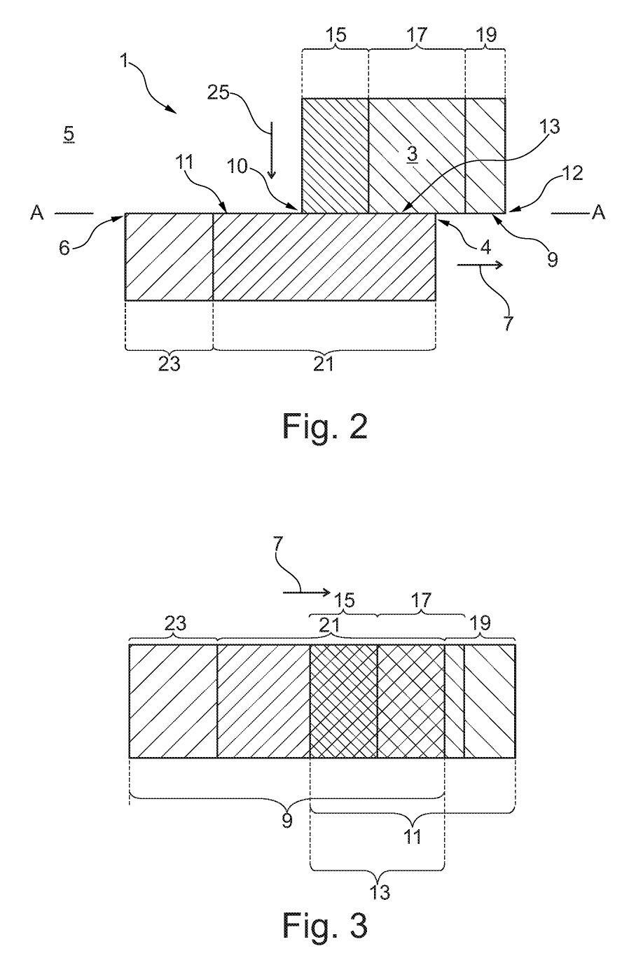

In the following, some features of specific embodiments of the present invention shall be explained in further detail with respect to FIGS. 2 and 3.

FIG. 2 shows a partial side view of a brush commutator arrangement 1 for an electrical machine according to an embodiment of the present invention. FIG. 3 illustrates sections and overlapping areas of a brush 3 and a commutator 5 in such brush commutator arrangement 1.

The brush 3 and/or the commutator 5 may mainly consist of a carbon-based material. In such carbon-based material, carbon provides for a major contribution to an electrical conductivity of the material, i.e. for more than 50%, preferably more than 90% or even more than 95% of the electrical conductivity of the material. Additional to carbon particles or a carbon matrix, the carbon-based material may comprise, inter alia, graphite flakes, binder components and/or boron-nitride particles. These additives may affect an electrical conductivity of the base material. For example, the influence of boron-nitride included into carbonic material has been described in U.S. Pat. No. 7,586,230 B2.

However, while providing the brush 3 and/or the commutator 5 mainly consisting of a carbon-based material may be beneficial e.g. with respect to lubrication or wear characteristics, it shall be noted that including significant amounts of metal particles such as copper particles into the brush 3 and/or commutator 5 shall not be excluded herein.

The brush 3 and/or the commutator 5 or sections thereof may be formed by pressing and sintering a powder comprising carbon particles and, optionally, comprising further additives as mentioned before. Due to such pressing and sintering, grains of carbon particles are typically formed such that the resulting carbon-based material obtains anisotropic physical characteristics.

For example, an electrical conductivity in such material differs in a direction along the grains as compared to a direction crossing the grains. Such anisotropic electrical conductivity characteristics may be beneficial for the brush commutator arrangement 1 described herein.

An electrical conductivity in a direction 25 orthogonal to the contact surface 9 of the brush 3 or a contact surface 11 of the commutator 5 is referred herein as “orthogonal electrical conductivity”. It is mainly this orthogonal electrical conductivity which affects electrical characteristics of the brush commutator arrangement 1 as generally an electric current in an electrical machine is supplied through the brush commutator arrangement 1 mainly in the direction of this orthogonal electrical conductivity. A lateral electrical conductivity in a direction perpendicular to the arrow 25 in FIG. 2 and therefore parallel to the contact surfaces 9, 11 may be significantly smaller than the orthogonal electrical conductivity and may be for example less than half of the orthogonal electrical conductivity. Such anisotropy in electrical conductivity may support that an electric current through the brush commutator arrangement 1 mainly flows in the direction 25 orthogonal to the contact surfaces 9, 11 but does not substantially flow in directions parallel to these contact surfaces 9, 11.

FIG. 2 shows a brush commutator arrangement 1 in which the brush 3 comprises three sections 15, 17, 19. The first section 15 is arranged at or close to the leading edge 10 of the brush 3. In other words, when operating the brush commutator arrangement 1 and moving the brush 3 and the commutator 5 relative to each other in the lateral displacement direction as indicated with the arrow 7 in FIGS. 2 and 3, the first section 15 of the brush 3 comes into contact with the commutator 5 first. The second section 17 is arranged adjacent to the first section 15 and comes into contact with the commutator 5 at a later point in time. Finally, the third section 19 is farthest from the leading edge 10 and closest to the trailing edge 12 of the brush 3.

Similarly, the commutator 5 may also be provided with multiple sections. In the embodiment shown in FIGS. 2 and 3, the commutator comprises a first section 21 close to a leading edge 4 and a second section close to a trailing edge 6.

Each one or both of the brush 3 and the commutator 5 may have two, three or more such sections 15, 17, 19, 21, 23.

The first section 15 of the brush 3 has a higher orthogonal electrical conductivity than the second section 17 and the second section 17 has a higher orthogonal electrical conductivity than the third section 19 of the brush 3 arranged downstream of the first and second sections 15, 17. Accordingly, close to the leading edge 10, the brush has a significantly higher orthogonal electrical conductivity than close to the trailing edge 12. Similarly, the first section 21 of the commutator 5 has a higher orthogonal electrical conductivity than the second section 23 such that the orthogonal electrical conductivity of the commutator 5 is also higher close to its leading edge 4 than close to its trailing edge 6.

The orthogonal electrical conductivities in the various sections 15, 17, 19, 21, 23 may differ for example by a factor of 5 or more, preferably by a factor of 10 or more. In other words, the orthogonal electrical conductivity in the first section 15 may be 5 times or more higher than the orthogonal electrical conductivity in the second section 17 and may be 25 or more times higher than the orthogonal electrical conductivity in the third section 19.

In a specific example of a brush commutator arrangement 1, and expressed in electrical resistivities instead of electrical conductivities, an orthogonal electrical resistivity in a first section 15 may be 9 μΩm, an orthogonal electrical resistivity in the second section 17 may be 45 μΩm and an orthogonal electrical resistivity in the third section 19 may be 225 μΩm. Lateral electrical resistivities in these first, second and third sections 15, 17, 19 may be three times higher, i.e. may be 27 μΩm, 135 μΩm and 675 μΩm, respectively. In other words, the lateral electrical conductivity is correspondingly three times lower in each section 15, 17, 19 than the orthogonal electrical conductivity.

It may be noted that, while in the embodiments shown in FIGS. 2 and 3, both the brush 3 and the commutator 5 comprise several sections 15, 17, 19, 21, 23, it may be sufficient to provide only one of the brush 3 and the commutator 5 with such multiple sections of varying orthogonal electrical conductivity.

Furthermore, it shall be noted that, while in the embodiments shown, the sections 15, 17, 19, 21, 23 are established such that the orthogonal electrical conductivity varies in a step-wise manner in the lateral displacement direction 7, such variation of the orthogonal electrical conductivity may also be established in a gradual or continuous manner. In other words, while sections 15, 17, 19, 21, 23 having a homogeneous orthogonal electrical conductivity within one and the same section are described with respect to FIGS. 2 and 3, such orthogonal electrical conductivity may continuously vary throughout the lateral displacement direction 7 and may for example continuously decrease from a position close to the leading edge 10, 4 to a position close to the trailing edge 12, 6 of the brush 3 or the commutator 5, respectively.

Having provided the brush 3 and/or the commutator 5 of the brush commutator arrangement 1 with an orthogonal electrical conductivity varying in a direction along the lateral displacement direction 7 as described herein, an electrical current density through an overlapping area 13 between the contact surface 9 of the brush 3 and the contact surface 11 of the commutator 5 may be affected such that, for almost all spatial configurations during displacing the brush 3 and the commutator 5 along the lateral displacement direction 7, the electrical current density does not exceed 130% of the rated maximal average electrical current density through the brush commutator arrangement 1.

By limiting the electrical current density also in spatial configurations in which the overlapping area 13 is small and is situated close to the trailing edges 6, 12 of the commutator 5 and the brush 3 to below 130% of the RMAECD, excessive sparking or arcing during commutation in an electrical machine may be prevented and wear and deterioration of the brush commutator arrangement 1 may be reduced. As a result, lifetime and reliability of the electrical machine may be improved.

Finally, it should be pointed out that terms such as “comprise”, “have”, etc. should not rule out the presence of further additional elements. The term “a” or “one” does not exclude the presence of a plurality of elements or subject matters. The term “at least one of A and B” may be interpreted as meaning “A and/or B”. The reference numbers in the claims solely serve the purpose of better readability and should not restrict the scope of protection of the claims in any manner.

### LIST OR REFERENCE SIGNS

1 brush commutator arrangement
2 lamella of commutator
3 brush
4 leading edge of the commutator
5 commutator
6 trailing edge of the commutator
7 lateral displacement direction
8 gap between commutator lamellae
9 contact surface of the brush
10 leading edge of the brush
11 contact surface of the commutator
12 trailing edge of the brush
13 overlapping area
15 first section of the brush
17 second section of the brush
19 third section of the brush
21 first section of the commutator
23 second section of the commutator
25 direction orthogonal to contact surfaces
100 electrical machine
102 stator
104 rotor
106 axis

1-13. (canceled)

14. An electrical machine with a brush commutator arrangement comprising:
at least two brushes; and
a commutator,
wherein each brush and the commutator are adapted and arranged such that, upon operating the electrical machine, the brush and the commutator are displaced relative to each other in a lateral displacement direction and a contact surface of the brush comes into mechanical contact with a contact surface of the commutator along an overlapping area thereby generating an electrical contact between the brush and the commutator along the overlapping area and an electric current being transmitted between the brush and the commutator through the overlapping area,
wherein an orthogonal electrical conductivity of at least one of the brush and the commutator in a direction orthogonal to a respective contact surface locally varies along the lateral displacement direction, and
wherein an orthogonal electrical conductivity distribution in the at least one of the brush and the commutator is adapted such that, even when operating the electrical machine at maximum allowable power, for at least 90% of all spatial configurations during displacing the brush and the commutator relative to each other, an electrical current density through the overlapping area does not exceed 130% of a rated maximal average electrical current density through the brush commutator arrangement.

15. The electrical machine according to claim 14, wherein, with respect to the lateral displacement direction, at least one of:
an orthogonal electrical conductivity in a first section of the brush is higher than an orthogonal electrical conductivity in a second section of the brush arranged downstream of the first section of the brush; and
an orthogonal electrical conductivity in a first section of the commutator is higher than an orthogonal electrical conductivity in a second section of the commutator arranged upstream of the first section of the commutator.

16. The electrical machine according to claim 15, wherein at least one of:
an average orthogonal electrical conductivity throughout an area unit within the first section of the brush is at least 5 times higher than an average orthogonal electrical conductivity throughout an area unit within in the second section of the brush; and
an average orthogonal electrical conductivity throughout an area unit within the first section of the commutator is at least 5 times higher than an average orthogonal electrical conductivity throughout an area unit within the second section of the commutator.

17. The electrical machine according to claim 14, wherein at least one of the brush and the commutator comprise at least a first section, a second section and a third section arranged behind each other along the lateral displacement direction and having different orthogonal electrical conductivities.

18. The electrical machine according to claim 17, wherein at least one of an average orthogonal electrical conductivity throughout an area unit within the first section of the brush is at least 5 times higher than an average orthogonal electrical conductivity throughout an area unit within in the second section of the brush and an average orthogonal electrical conductivity throughout the area unit within the second section of the brush is at least 5 times higher than an average orthogonal electrical conductivity throughout an area unit within in the third section of the brush; and
an average orthogonal electrical conductivity throughout an area unit within the first section of the commutator is least 5 times higher than an average orthogonal electrical conductivity throughout an area unit within the second section of the commutator and an average orthogonal electrical conductivity throughout an area unit within the second section of the commutator is least 5 times higher than an average orthogonal electrical conductivity throughout an area unit within the third section of the commutator.

19. The electrical machine according to claim 14, wherein at least one of in the brush and in the commutator, the orthogonal electrical conductivity continuously varies in the lateral displacement direction.

20. The electrical machine according to claim 14, wherein at least one of in the brush and in the commutator, the orthogonal electrical conductivity varies in a step-wise manner in the lateral displacement direction

21. The electrical machine according to claim 14, wherein at least in one of the brush and the commutator, the electrical conductivity is anisotropic and an orthogonal electrical conductivity in the direction orthogonal to the respective contact surface is substantially higher than a lateral electrical conductivity in the direction parallel to the respective contact surface.

22. The electrical machine according to claim 21, wherein the orthogonal electrical conductivity is at least 50% higher than the lateral electrical conductivity.

23. The electrical machine according to claim 14, wherein at least one of the brush and the commutator are made from a material in which carbon provides for a major contribution to the electrical conductivity.

24. The electrical machine according to claim 23, wherein the orthogonal electrical conductivity of the at least one of the brush and the commutator locally varies along the lateral displacement direction as a result of a varying content of at least one of graphite flakes, binder components and boron-nitride comprised in a carbon matrix.

25. The electrical machine according to claim 14, wherein the electrical machine is adapted for being applied in a fuel pump.

26. A fuel pump for a vehicle comprising an electrical machine according to claim 14.
